(19) United States
(12) Patent Application Publication
(10) Pub. No.: US 2025/0237102 A1
(43) Pub. Date: Jul. 24, 2025

(54) UNIVERSAL MOUNTING INTERFACE

(71) Applicant: Hampton Products International Corporation, Foothill Ranch, CA (US)

(72) Inventor: Hossein Molaie Shargh, Rancho Santa Margarita, CA (US)

(21) Appl. No.: 19/015,220

(22) Filed: Jan. 9, 2025

Related U.S. Application Data
(63) Continuation-in-part of application No. 18/419,465, filed on Jan. 22, 2024.

(51) Int. Cl. E05F 3/22

(52) U.S. Cl. CPC E05F 3/227; E05Y 2600/626

(57) ABSTRACT

A mounting interface for a fixture such as a door closer mechanism is configured to attach to a mount surface such as a door. The mounting interface includes attachment points for attaching the door closer mechanism to the mounting interface, effectively attaching the door closer mechanism to the mount surface. The mounting interface has a plurality of cross members extending across an opening defined by the frame. The cross members are movable relative to the frame and have through slots that can be aligned with pre-existing mount holes formed in the mount surface. Fasteners extending through the cross member through slots and into the pre-existing mount holes attach the mounting interface to the mount surface.

### RELATED APPLICATIONS

This application is a continuation-in-part of U.S. application Ser. No. 18/419,465, which was filed Jan. 22, 2024, the entirety of which is hereby incorporated by reference.

### FIELD OF THE INVENTION

The present invention relates generally to hardware, and more particularly to a mounting interface facilitating mounting of replacement hardware such as, for example, door closers.

### BACKGROUND OF THE INVENTION

Hardware items are ubiquitous in homes, offices, and other buildings. A variety of suppliers provide numerous items, often performing the same or similar functions, for a variety of uses. When a building is originally equipped, often a single supplier provides hardware items for particular uses, although a variety of suppliers may be used for different items.

Due to use, these items may fail or otherwise lose function over time. Alternatively, an owner or user of the building may desire to replace hardware items to modify functional operation of those items or to change the aesthetic look of those items.

Similar items from different manufactures may have slightly different footprints, or the similar items may be mounted in a slightly different manner. As an example, a door closer assembly generally has a door closer mechanism affixed to a door by screws. In some cases the door closer mechanism may be directly affixed to the door by the screws. In the event of replacement of the door closer assembly, it is often desirable to reuse mounting holes of the prior installation for a variety of reasons, including cosmetic reasons as well as for ease of installation and integrity of the door. However, the relative position of the mounting holes may vary from manufacturer to manufacturer, or even between different models of door closers by the same manufacturer. Indeed, mounting hole positions for door closers may be found in a dizzying array of combinations.

### BRIEF SUMMARY

According to embodiments disclosed herein, a mounting interface enables replacement hardware fixtures to be mounted to a mount surface using pre-existing mount holes in the moun surface that were used for a previously-installed fixture. A mounting interface is configured to be attached to the mount surface using the pre-existing mount holes. The replacement fixture can then be attached to the mounting interface.

The mounting interface can have adjustable cross members that can be aligned with the pre-existing mount holes, and can have attachment points specifically configured to align with corresponding attachment points of the replacement fixture. To that extent, in some embodiments a kit can be provided including the replacement fixture and a mounting interface sized and shaped to complement the replacement fixture, but adjustable to be mountable using the pre-existing mount holes.

In accordance with one embodiment the present specification provides a mounting interface for a door closer, comprising a frame and a plurality of elongated cross members. The frame includes a pair of spaced apart elongated beams, each of the beams comprising an elongated beam slot. The beams can be arranged so that the beam slots face one another and an opening is defined between the beams. Each cross member can have a first coupling portion at a first end and a second coupling portion at a second end. The first and second coupling portions can be configured to slidably fit within the beam slots. Each cross member can further comprise an elongated through slot between the first and second coupling portions. The plurality of cross members span the opening between the beams, and a back of the frame defines a planar back surface.

Some such embodiment can additionally comprise a first post and a second post, each of the first post and second post configured to extend between the first beam and the second beam to be attached to the first beam and second beam via post fasteners.

Additional embodiments can be combined with a door closer mechanism, wherein the door closer mechanism has mechanism attachment points and the posts have interface attachment points, and wherein the frame and door closer mechanism are sized and configured so that the mechanism attachment points align with the interface attachment points.

In further embodiments, the interface is configured so that when the post fasteners are tightened, the cross members are held tightly within the beam slots in a manner resisting movement of the cross members relative to the beams.

In accordance with another embodiment the present disclosure presents a replacement door closer assembly kit. The kit comprises a door closer mechanism, a frame, and a plurality of elongated cross members. The door closer mechanism can have a housing with a plurality of mechanism attachment points. The frame can include a pair of spaced apart elongated beams and a pair of posts. The posts can be releasably attached to the beams so as to extend between the beams and defining a plurality of interface attachment points, each of the beams comprising an elongated beam slot, the beams arranged so that the beam slots face one another and an opening is defined between the beams. The frame can be configured to lie flat against a door so that the interface attachment points align with the mechanism attachment points. Each cross member can have a first coupling portion at a first end and a second coupling portion at a second end. The first and second coupling portions can be configured to slidably fit within the beam slots, each cross member further comprising an elongated through slot between the first and second coupling portions. The plurality of cross members can span the opening between the beams. A back of the frame can define a planar back surface.

In some embodiments the frame is configured so that the plurality of cross members can be inserted into the beam slots and removed from the beam slots when the post fasteners are loosened.

In accordance with another embodiment a method is provided for mounting a mechanism onto a mount surface that comprises a plurality of pre-existing mount holes. The method comprises attaching a mounting interface to the mount surface, and attaching the mechanism to the mounting interface. The mounting interface can comprise a first beam, a second beam and a plurality of cross members. Attaching the mounting interface can comprise arranging the plurality of cross members so that a first coupling portion of each cross member is engaged in an elongated beam slot of the first beam and a second coupling portion of each cross member is engaged in an elongated beam slot of the second beam. Each cross member can have an elongated through-slot between the first coupling portion and the second coupling portion. The first and second beams can be arranged so that back surfaces of the first and second beams are in contact with the mount surface, and the plurality of pre-existing mount holes is arranged in an opening defined between the first beam and the second beam. At least two of the cross members can be positioned relative the first beam and second beam so that the through-slot of each of the at least two cross members is aligned with at least one of the plurality of pre-existing mount holes. The method further includes advancing a fastener into each of the plurality of pre-existing mount holes and aligned cross member so that the beams are attached to the mount surface. Attaching the mechanism to the mounting interface can comprise aligning a mechanism attachment point of the mechanism with an interface attachment point of a post that is connected to and extends between the first beam and the second beam, and advancing a fastener through the aligned mechanism attachment point and interface attachment point.

In additional embodiments the plurality of cross members can be disposed between the post and a second post that is also connected to and extends between the first beam and the second beam.

In another embodiment positioning the at least two of the cross members can comprise sliding the first and second coupling portions within the beam slots of their respective beams. In some such embodiments a first one of the at least two of the cross members is disposed

on a first side of the post and a second one of the at least two of the cross members is disposed on a second side of the post.

In further such embodiments, a second post is connected to and extends between the first beam and the second beam, and post fasteners connect the post and second post to the first and second beams, and comprising tightening the fasteners.

A further embodiment can comprise tightening the post fasteners after positioning the at least two of the cross members. A still further embodiment can comprise moving a position of the second post relative to the first beam and second beam prior to tightening the post fasteners. In yet additional embodiments, the post comprises an elongated post through slot, and the interface attachment point is disposed within the post through slot.

Some embodiments provide a mounting interface for a door closer, comprising: a frame including a plurality of attachment points and with at least one opening therethrough; and a plurality of spacers dimensioned to fit against portions of the plate about a set of opposing sides of the at least one rectangular opening, the spacers each having a through slot.

In some embodiments opposing ends of the spacers include cutouts to fit within the opposing sides of the at least one opening. In some embodiments the cutouts fit against the opposing sides of the at least one opening. In some embodiments, a depth of the cutouts is less than a thickness of the plate about the opposing sides of the at least one opening. In some embodiments, the through slot of the spacers has chamfered edges. In some embodiments the mounting interface includes a stepped profile, with different portions of the interface having different thicknesses. In some embodiments portions of the interface including the attachment points have a greater thickness than portions of the interface about the set of opposing sides of the at least one rectangular opening. In some embodiments the attachment points comprise threaded holes. In some embodiments, a thickness of the opposing ends of the spacers is less than or equal to a difference in thickness between the portions of the interface including the attachment points and the portions of the interface about the set of opposing sides of the at least one rectangular opening. In some embodiments, the at least one opening comprises a plurality of openings. In some embodiments the plurality of openings are separated by a reinforcing bar. In some embodiments, the through slot extends between the cutouts at the opposing ends of the spacers. In some embodiments the at least one opening comprises a rectangular opening.

Some embodiments provide a mounting interface for a door closer, comprising: a frame including a plurality of attachment points, the frame defining at least one opening, each at least one opening having at least one section having linear parallel opposing sides; and a plurality of components having opposing walls defining a through slot, at least part of the opposing walls coupled by a coupling at each end, the plurality of components dimensioned such that the coupling at each end fit against portions of the frame about the at least one opening.

In some embodiments, the coupling at each end of the components has a thickness less than a depth of the through slot. In some embodiments, the frame has a first thickness about the plurality of attachment points and a second thickness about the linear parallel opposing sides of the at least one opening, with the first thickness greater than the second thickness. In some embodiments the coupling at each end of the components has a thickness less than or equal to a difference between the first thickness and the second thickness. In some embodiments the depth of the through slot is less than the first thickness.

Some embodiments provide a mounting interface for a door closer, comprising: a rectangular frame having an upper beam, a lower beam, and a first post and a second post coupling opposing ends of the upper beam and lower beam, the upper beam parallel to the lower beam and the first post parallel to the second post, the first post and the second post having a greater thickness than the upper beam and the lower beam, the first post and the second post each having threaded holes; and a plurality of spacers dimensioned to fit against the upper beam and the lower beam, the plurality of spacers each including a through slot, the through slot having a depth less than or equal to the thickness of the first post and the second post. In some embodiments the portion of the coupling that fits against portions of the frame comprises a portion that fits against a face of the portions of the frame about the at least one opening, with the portion of the coupling that fits against the face of the portions of the frame having a thickness less than or equal to a difference between the first thickness and the second thickness, such that the portion of the coupling does not extend beyond a plane defined by the plurality of attachment points with the portion of the coupling fitted against the face of the portions of the frame about the at least one opening.

In some embodiments, the spacers each include opposing walls defining a length of the through slot, with cutouts at opposing ends of the opposing walls, the cutouts being positioned such that portions of the opposing walls fit between the upper beam and the lower beam. Some embodiments further comprise at least one reinforcing bar extending between the upper beam and the lower beam. In some embodiments, the through slot has chamfered edges on a side of the through slot opposite the cutouts.

These and other aspects of the invention are more fully comprehended upon review of this disclosure.

### BRIEF DESCRIPTION OF THE FIGURES

FIG. 1 shows a door closer attached to a door by way of a mounting interface having features as discussed in this specification.

FIG. 2 shows the arrangement of FIG. 1 with the door closer removed so that the mounting interface is visible.

FIG. 3 is a front isometric view of the mounting interface of FIG. 2, showing adjustable spacers, with the spacers positioned in the mounting interface.

FIG. 4 is a rear isometric view of the mounting interface of FIG. 3.

FIG. 5 is an exploded view of the mounting interface with adjustable spacers of FIG. 3.

FIG. 6 is a front isometric view of another embodiment of a mounting interface with adjustable spacers, with the spacers positioned in the mounting interface.

FIG. 7 is a front isometric view of another embodiment of a mounting interface having inventive features.

FIG. 8 is an exploded view of the mounting interface of FIG. 7.

### DETAILED DESCRIPTION

As will be discussed in more detail in embodiments presented below, the present specification provides a mounting interface 200 that enables a replacement fixture or mechanism 115 to be mounted to a mount surface using preexisting mount holes left in the mount surface by an original fixture or mechanism. The mounting interface 200 has a frame 210 that defines a window 222 or opening. One or more cross members, or spacers 215, are supported by the frame 210 and span across the window 222. The cross members 215 are movable and define through slots 244. The frame 210 can be placed against the mount surface, and the spacers 215 positioned so that through slots 244 align with preexisting mount holes in the mount surface. Fasteners can be advanced through the through slots 244 into the preexisting mount holes so as to attach the mounting interface 200 to the mount surface. The mounting interface 200 also defines interface attachment points 214 that correspond with mechanism attachment points 119 of the replacement fixture or mechanism 115. The replacement fixture 115 can thus be placed on the mounting interface 200 and attached thereto using fasteners extending through aligned attachment points 119, 214. As such, the replacement fixture 115 can be attached to the mount surface via the mounting interface 200 using preexisting mount holes.

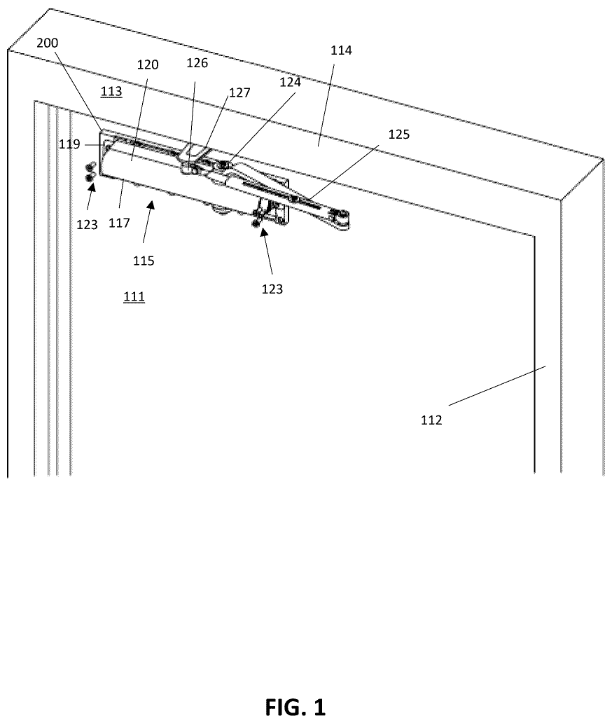

With initial reference to FIG. 1, a typical door 111 is illustrated seated within a typical door frame 113 in a closed configuration. The door frame 113 can be configured to complementarily receive the door 111 so as to hingedly open and close therewithin. The door frame 113 can be considered to completely surround the door 111, and can include casing side portions 112 adjacent the door, a header portion 114 above the door 111, and a sill portion below the door.

A door closer assembly 115 is mounted so as to be operably interposed between the door 111 and the door frame 113. The illustrated door closer assembly 115 comprises a door closer mechanism 120 and an arm structure 125. As shown, the door closer mechanism 120 includes a housing 122 that can enclose componentry such as hydraulic-actuated structures. The door closer mechanism 120 is shown attached to the door 111 while the arm structure 125 has a first end 124 that extends from the door closer mechanism 120 and a second end 126 that is attached to the door frame 113 by way of a bracket 127 extending from the header portion 114 of the frame 113. The arm structure 125 can comprise an articulating arm mechanism, typically comprising two hingedly-connected arms. As such, when the door 111 is opened, the door closer mechanism 120 operates between the door 111 and door frame 113 so as to control closure of the door 111 in a desired fashion. Notably, in some installations, the door closer mechanism 120 can be attached to the door frame 113 while the arm structure 125 is attached to the door 111. For efficiency, this specification will use the example of a door closer mechanism 120 attached to the door 111, but it is to be understood that the principles discussed herein also apply to other modes and locations of installation.

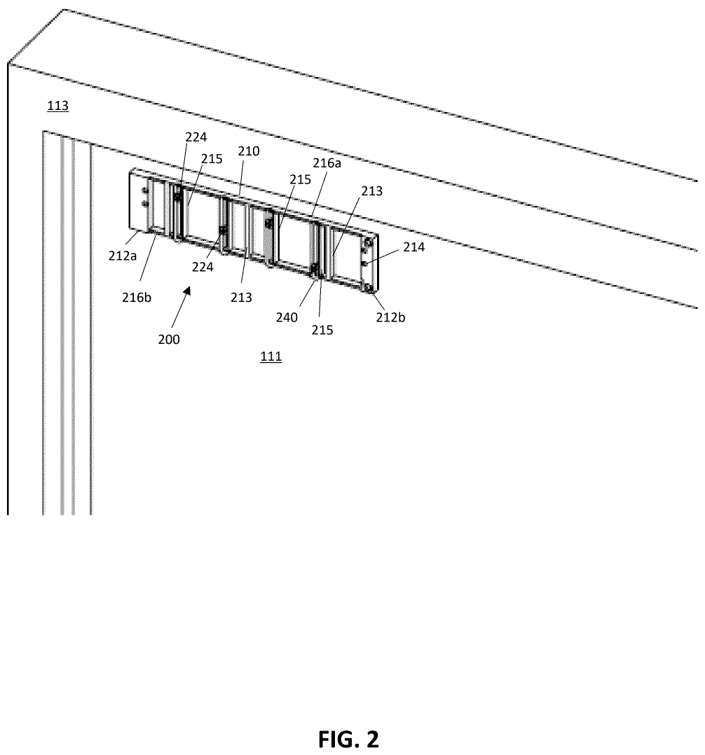

The door closer assembly 115 as shown in FIG. 1 is not directly attached to the door 111. Rather, a mounting interface 200 is directly attached to the door 111 (see FIG. 2), and the door closer mechanism 120 is directly attached to the mounting interface 200. Typically, door closer mechanisms 120 are attached directly to associated doors 111 (or door frames 113, as the case may be) when initially installed. The arrangement in FIG. 1 is intended to represent a replacement door closer assembly 115, in that the assembly may be a replacement for a prior door closer assembly that was previously mounted directly to the door 111, resulting in pre-existing mounting holes (not shown) being formed in the door 111.

With additional reference to FIG. 2, the mounting interface 200 comprises interface attachment points 214 which, in the illustrated embodiment, comprise threaded holes. The door closer mechanism 120 in turn has mechanism attachment points 119, which can be apertures that can be threaded or unthreaded, and which align with the interface attachment points 214. As such, fasteners such as bolts 123 can extend through the mechanism attachment points 119 and interface attachment points 214 so as to attach the door closer mechanism 120 securely to the mounting interface 200. In some embodiments the mounting interface 200 is manufactured specifically for a corresponding door closer mechanism 120 so that the attachment points 119, 214 align. As such, a complementary mounting interface 200 and door closer assembly 115 can be packaged together in a kit along with associated bolts 123.

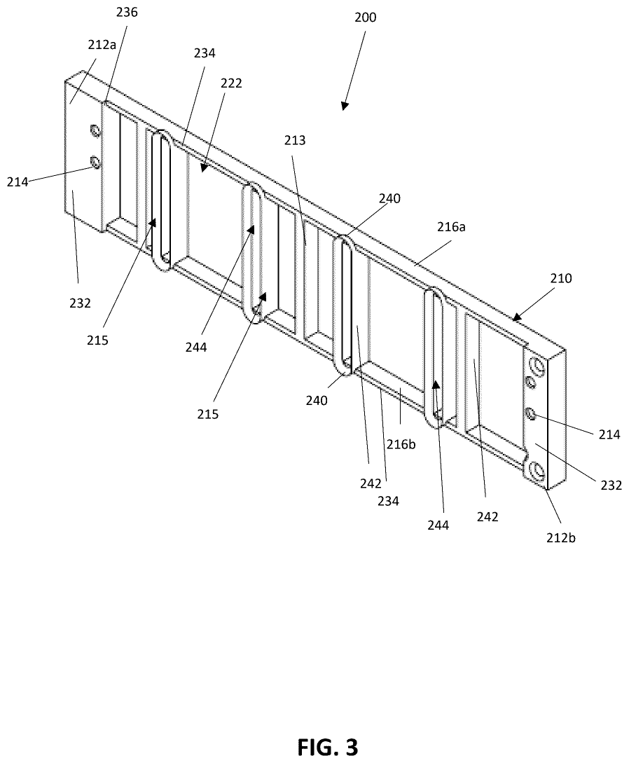

With additional reference next to FIGS. 3-5, the illustrated mounting interface 200 is substantially planar and rectangular in shape. The illustrated mounting interface 200 comprises a frame 210 made up of a left post 212a, a right post 212b, an elongated top beam 216a and an elongated bottom beam 216b. The posts 212a,b preferably are spaced apart yet parallel to one another. The beams 216a,b also preferably are spaced apart yet parallel to one another. The elongated top beam 216a and bottom beam 216b extend between the left post 212a and the right post 212b, defining the frame 210 having a rectangular outline shape and being substantially planar. A window 222 is defined between the posts 212a,b and beams 216a,b. In the illustrated embodiment a plurality of spaced-apart support bars 213 extend between the top beam 216a and bottom beam 216b. The illustrated support bars 213 are rigidly attached to the beams 216a,b, and divide the window 22 into a plurality of openings. The illustrated embodiment employs three support bars 213. It is to be understood that other embodiments can employ 1, 2 or more support bars 213, and some embodiments can employ no support bars.

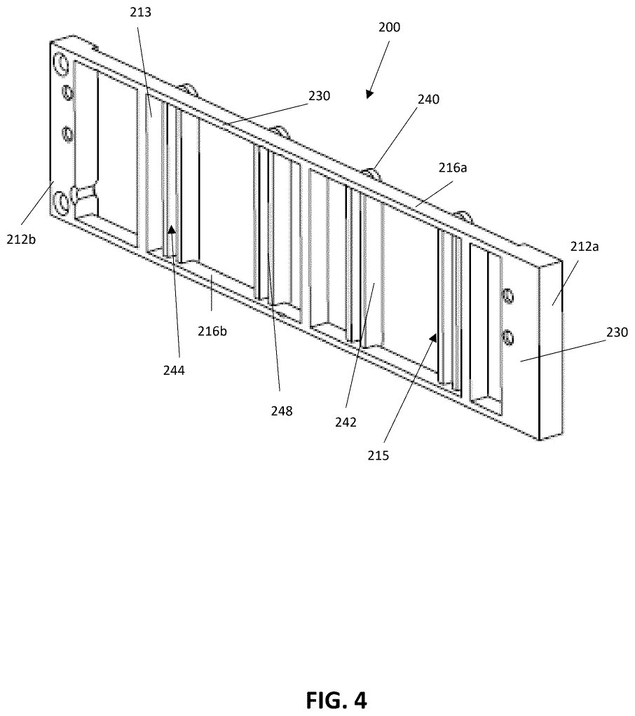

As shown in FIG. 4, the frame 210 has a planar back surface 230 that spans the posts 212a,b and beams 216a,b, and can also include the support bars 213. With reference again to FIG. 3, each of the posts 212a,b has a post front surface 232, and the post front surfaces 232 are coplanar. Each of the beams 216a,b has a beam front surface 234, and the beam front surfaces 234 are also coplanar. The post front surfaces 232 and beam front surfaces 234 preferably are parallel but spaced-apart an offset distance 236 from one another, with the beam front surfaces 234 being closer to the frame back surface 230 than are the post front surfaces 232. As such, the beams 216a,b have a front-to-back thickness that is less than a front-to-back thickness of the posts 212a,b.

As discussed above, the posts 212a,b can have threaded interface attachment points 214 formed therewithin and spaced and configured to align with corresponding mechanism attachment points 119 complementarily formed and located on a corresponding door closer mechanism 120.

Continuing with reference to FIGS. 2-5, a plurality of cross members, or spacers 215, are configured to be placed into contact with the frame 210 so as to span the window 222. More specifically, in the illustrated embodiment each spacer 215 contacts and extends between the front surfaces 234 of the top beam 216a and bottom beam 216b. The spacers 215 are not integrally formed with the frame 210, and can be positioned as desired relative to the frame 210. Coupling portions 240 are formed at opposing ends of each spacer 215. As shown, the coupling portions 240 rest against the beam front surfaces 234 when in place upon the frame 210. The coupling portions 240 each have a thickness no greater than, and preferably substantially equal to or less than, the offset distance 236 between the post front surfaces 232 and beam front surfaces 234. As such, the spacers 215 preferably do not extend forwardly past the post front surfaces 232.

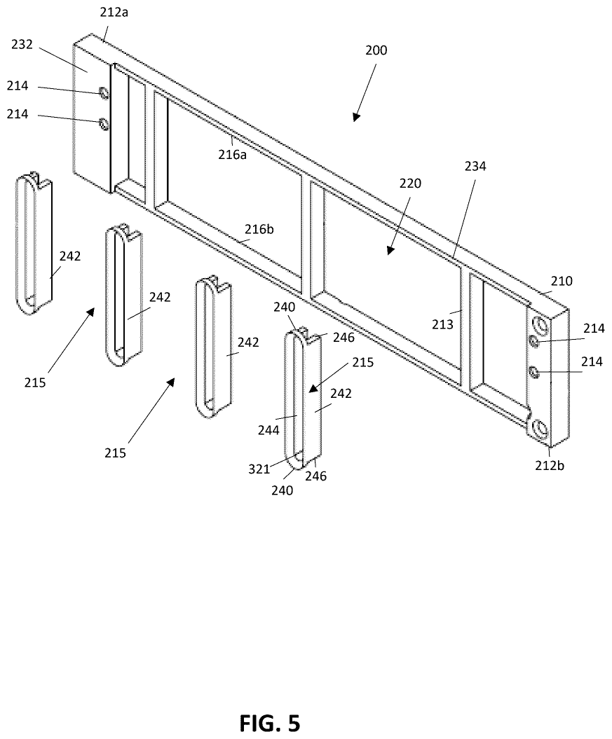

Each spacer 215 preferably is elongated and can include opposing, spaced apart side walls 242 that define an elongated through slot 244 therebetween. The side walls 242 preferably are dimensioned so as to allow passage of a shaft, of a predetermined diameter, through the slot 244. The shaft may be a shaft of a fastener 224 such as a screw or bolt. The walls 242, however, are sufficiently close to one another to prevent passage of a head of the screw or bolt therethrough. As best shown in FIGS. 2 and 5, outer edges of the slot can be chamfered. The chamfered outer edges of the slot allow, for example, for a beveled edge of a head of a screw or bolt 224 to lie against the chamfered outer edges, with a top of the head of the screw or bolt flush with or below outer edges of the walls 242 of the associated spacer 215.

As shown, the side walls 242 have a depth along their length. Preferably the wall depth is no greater than the thickness of the frame 210, which frame thickness can be defined between the back surface 230 and the post front surfaces 232. Cutouts 246a,b are provided at the opposing ends of the spacers 215, on a rear side of the spacers. The cutouts 246 define the thickness of the 240 coupling portions. Preferably the side walls 242 each have a length that approximates the distance across the window 222 between the top and bottom beams 216a,b. In this manner, and as best shown in FIGS. 3 and 4, when a spacer 215 is in place on the frame 210 with the coupling portions resting on the front surfaces 234 of the beams, back surfaces 248 of the side walls 242 are spaced from, or at least do not extend beyond, the back surface 230 of the frame 210, as depicted in FIG. 4. In this manner, and with additional reference to FIG. 2, when the frame 210—with spacers 215—is mounted to a door 111, the back surfaces 248 of the spacer side walls 242 do not apply pressure to the door 111, or at least do not apply excessive pressure such that installation of the mounting interface 200 is made excessively difficult.

Continuing with reference to FIG. 2, as discussed above, since the illustrated embodiment contemplates a replacement door closer assembly 115, it is anticipated that pre-existing mount holes are present in the door 111 (i.e., the mount surface) as a result of the previously-installed door closer assembly. In operation, the frame 210 can be temporarily held in place on the door 111 (such as by an installer during installation), and spacers 214 placed so that their through-slots 244 align with preexisting door holes. Fasteners 224 such as screws can then be advanced through each relevant spacer slot 244 and into the aligned preexisting door holes. The coupling portions 240 of the spacers 215 combine to hold the frame 210 against the door 111. In this manner, the mounting interface 200 can be mounted onto the door 111 using the preexisting mount holes and, in some embodiments, without requiring any new door holes.

With reference again to FIG. 1, once the mounting interface 200 has been secured to the door 111, the door closer mechanism 120 can be attached to the mounting interface 200 by advancing bolts 123 through aligned mechanism attachment points 119 and interface attachment points 214.

In some embodiments, the reinforcing bars 213 are positioned laterally within the frame 210 at positions known or believed to not overlay expected possible mounting hole locations in a door 111. The expected possible mounting hole locations may, in some embodiments, be determined based on knowledge of mounting hole patterns for door closer mechanisms of various manufacturers.

The embodiment depicted in FIGS. 2-5 employs four spacers 215. In additional embodiments, lesser or greater numbers of spacers 215 may be used, depending on the number and locations of preexisting mounting holes available in a door 111 and/or a desired number of screws or bolts to be used to mount the mounting interface 200 to the door. In some embodiments, several spacers 215 can be included in a kit, and a user may decide to use all or less than all of the provided spacers 215. In some instances, multiple preexisting mount holes may be aligned, and thus a single spacer 215 may accommodate two or more screws/bolts.

With reference again to FIG. 4, in the illustrated embodiment a depth of the spacer walls 242 is less than a thickness of the frame 210 so that the back surface 248 of the spacers 215 is spaced from the frame back surface 230. In this manner, when fasteners through the spacers 215 are secured to the mount surface, the space between the back surfaces 248 of the spacers 215 and the frame back surface 230 allows for some deflection of the spacer 215 during tightening of the fasteners without interfering with the fit of the mounting interface 200 against the door 111.

In some embodiments the mounting interface 200 may not be rectangular, and the window 222 and/or openings in the mounting interface for the spacers 215 also may not be rectangular. In some embodiments the openings include portions having opposing parallel linear sides. The opposing parallel linear sides allow for placement of the spacers as discussed above, with respect to the rectangular openings in the interface (which also have portions having opposing parallel linear sides).

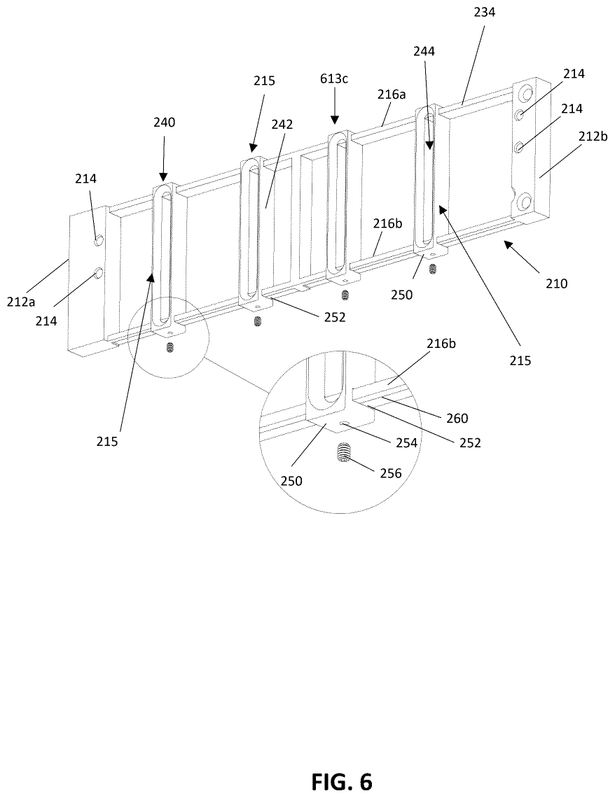

With reference next to FIG. 6, another embodiment of a mounting interface 200 is depicted. In this embodiment four spacers 215 can be selectively placed in desired locations along a frame 210 so as to span a window 222 defined between spaced apart posts 212 and beams 216. As with the embodiment discussed above, the mounting interface 200 can be attached to a door 111 via the spacers 215 by advancing screws or the like through elongated slots 244 defined by the spacers 215, and a door closer mechanism 120 can be attached to the mounting interface 200.

Each spacer 215 comprises an elongated through slot 244 defined between elongated side walls 242. The side walls 242 terminate adjacent either end of the slot 244 at a coupling portion 240. In the illustrated embodiment, each coupling portion 240 comprises an end wall 250. A receiver space 252 is formed between ends of the side walls 242 and the end wall 250. The receiver space 252 resembles a slot, and is sized and configured to fit over an associated beam so that the beam fits into the receiver space, with the end wall on one side of the associated beam and the side walls on the opposing side of the associated beam as shown in FIG. 6.

FIG. 6 includes a detail view of a lower end of the spacer 613a and surrounding portion of the lower beam 621. As shown, the end wall can include a threaded hole 254 configured to receive a set screw 256. The set screw may be screwed into the hole 254 so as to bias against the bottom beam, frictionally holding the spacer in place with respect to the bottom beam. In some embodiments a threaded hole 254 and set screw arrangement can be provided at a top end of the spacer instead of or in addition to the illustrated arrangement at the bottom end of the spacer.

Continuing with reference to FIG. 6, in the illustrated embodiment, the bottom surface of the lower beam is contoured so that a wall, or lip, extends longitudinally along the length of the beam. The beam is further configured so that the wall or lip is disposed forwardly of the threaded hole 254 when the spacer is in place on the frame. As such, when the set screw is advanced, it will contact the beam behind the wall or lip, thus preventing the spacer from being pulled forwardly off of the frame.

In this arrangement, when the spacer is placed in a desired position along the frame, the set screw can be tightened so as to retain the spacer at the desired position. However, even if the set screw were to loosen somewhat so that the spacer became movable relative to the frame, the lip will block the set screw so that the spacer cannot be pulled forwardly off of the frame. Preferably, the lip and set screw are configured so that the set screw must be rotated 2-4 rotations from a tightened position in order for the set screw to clear the lip so that the spacer can be pulled forwardly off the frame. Also, in some embodiments, during installation the spacer can first be simply placed on the frame and the set screw partially advanced so that the spacer is blocked by the lip/set screw from falling off the frame, but is sufficiently loose to be slid into a precisely-desired position. Once the desired position is achieved, the set screw can be fully tightened so as to secure the spacer in place.

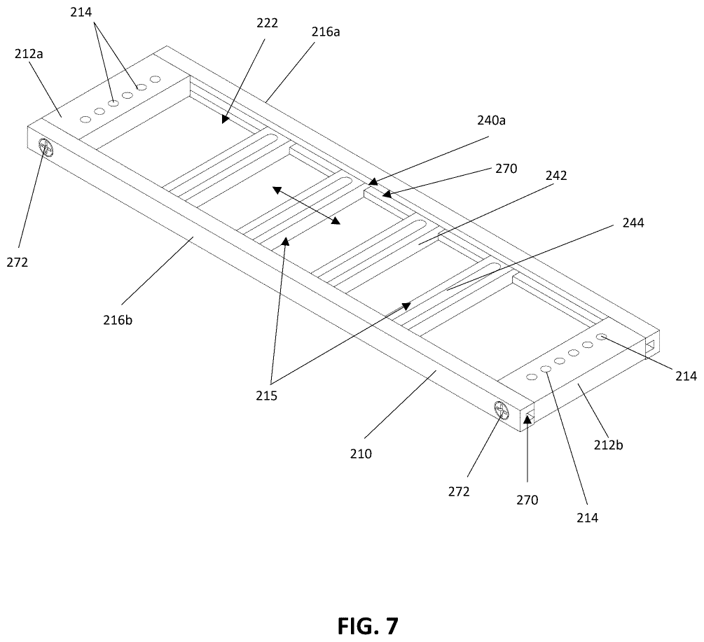

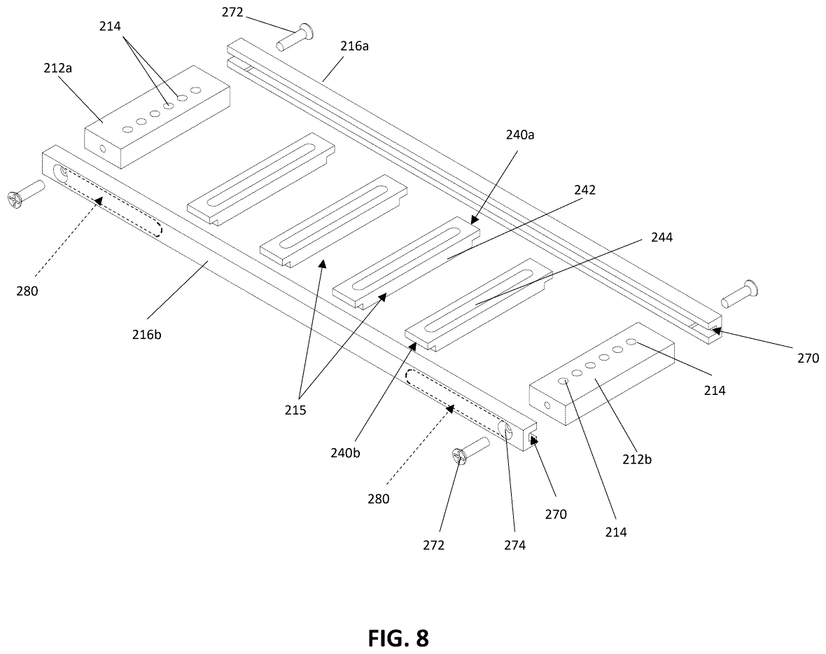

With reference next to FIGS. 7 and 8, another embodiment of a mounting interface comprises a top beam, a bottom beam, a left post and a right post that are formed separately from one another. The top and bottom beams are elongated and each comprises an elongated beam slot having a slot width and a slot depth. The top and bottom beams can be connected to the left and right posts via post fasteners that extend through apertures formed in the beams. In the illustrated embodiment, each of the posts comprises a plurality of spaced apart interface attachment points. When the beams and posts are connected to one another, a window is defined therebetween. Preferably, and as shown, the beam slots open toward the window.

With continued reference to FIGS. 7 and 8, a plurality of cross members, or spacers, are provided. Each spacer is elongated, extending from a top coupling portion to a bottom coupling portion. Each spacer comprises an elongated through-slot defined between opposing side walls. The side walls terminate at the coupling portions. Preferably a thickness of each coupling portion complements the width of the beam slots so that each coupling portion fits snugly, but slidably, within an associated beam slot. With the coupling portions arranged within respective beam slots, each spacer is blocked from being pulled forwardly or backwardly from the frame.

In the illustrated embodiment, the elongated side walls are about the same length as the posts and the coupling portions extend beyond the ends of the side walls a distance that approximates the depth of the beam slots. As such, when the frame is assembled, the coupling portions are received within the beam slots and each spacer spans the window between the top beam and the bottom beam. In the illustrated embodiment the beams and posts have substantially the same thickness so that a front surface of the beams is substantially coplanar with a front surface of the posts.

In operation, a user can determine, based on the number and location of preexisting holes in an associated door, how many spacers are desired to be used to secure the mounting interface to the door. The frame can then be assembled with the desired spacers extending across the window, but without fully tightening the post fasteners. The spacers can then be slid to desired locations to properly align with selected preexisting door holes. The post fasteners can be tightened which, preferably, securely tightens the spacers in the desired locations. The mounting interface can then be attached to the door via screws or other fasteners directed through the spacer through-slots into preexisting mount holes as desired.

Once the mounting interface is attached to the door, the replacement closer mechanism can be attached to the mounting interface. In the illustrated embodiment each post comprises several interface attachment points that are spaced so as to complement the positions of mechanism attachment points. The several interface attachment points preferably are spaced and positioned so that a user can use any desired ones of the interface attachment points. As such, the door closer mechanism can be mounted at a desired height relative to the mounting interface.

With continued reference to FIGS. 7 and 8, in yet another embodiment, each beam can include an elongated beam through-slot portion, which is shown in dotted lines in FIG. 8. The elongated beam through-slot portion can be configured to allow the associated post to be mounted in a range of positions along the length of the beams. As such, a user can adjust the distance between opposing posts so as to accommodate differences in mounting configurations between closer mechanisms. Also, in some such embodiments it is contemplated that one or more spacers can be positioned to as to extend between the beams on a side of a post opposite the window, so that the mounting interface can be configured to accommodate a broader range of preexisting door mount hole locations, including a range of preexisting mount hole locations that span a width greater than a width between mechanism attachment points of the replacement door mechanism.

In still additional embodiments, the posts can have their own elongated through-slots configured to align with mechanism attachment points of varying spacing and configuration. In yet further embodiments, a user can apply fasteners on one or more of the spacers in a fashion that aligns with mechanism attachment points, and the door closer mechanism can be attached to the frame via a spacer rather than only via one of the posts. More precisely, the structures described herein as posts can be versions of cross members. In still further embodiments the posts can include coupling portions (similar to the illustrated spacers) that are configured to be received in the elongated beam slots, and the posts can be moved and positioned similar to the spacers.

The embodiments discussed above have used a door closer assembly to illustrate inventive aspects. It is to be understood that the principles discussed herein can be employed with other hardware. For example, a mounting interface employing such principles can be used for structures such as magnetic door holder systems and doorknob/lockset frames. Also mounting interfaces employing inventive principles discussed herein can be used in connection with replacement light fixtures such as chandeliers and other fixtures such as ceiling fans, stereo speakers, television wall mounts, camera mounts, and the like.

Although this disclosure has discussed various embodiments, it should be recognized that aspects of the various embodiments discussed above can be combined in order to create additional embodiments, and that the invention should be defined only by the scope of the claims that eventually issue.

What is claimed is:

1. A mounting interface for a door closer, comprising:
a frame including a pair of spaced apart elongated beams, each of the beams comprising an elongated beam slot, the beams arranged so that the beam slots face one another and an opening is defined between the beams;
a plurality of elongated cross members, each cross member having a first coupling portion at a first end and a second coupling portion at a second end, the first and second coupling portions configured to slidably fit within the beam slots, each cross member further comprising an elongated through slot between the first and second coupling portions;
wherein the plurality of cross members span the opening between the beams; and
wherein a back of the frame defines a planar back surface.

2. The mounting interface of claim 1, additionally comprising a first post and a second post, each of the first post and second post configured to extend between the first beam and the second beam to be attached to the first beam and second beam via post fasteners.

3. The mounting interface of claim 2 in combination with a door closer mechanism, wherein the door closer mechanism has mechanism attachment points and the posts have interface attachment points, and wherein the frame and door closer mechanism are sized and configured so that the mechanism attachment points align with the interface attachment points.

4. The mounting interface of claim 1, wherein the interface is configured so that when the post fasteners are tightened, the cross members are held tightly within the beam slots in a manner resisting movement of the cross members relative to the beams.

5. A replacement door closer assembly kit, comprising:
a door closer mechanism having a housing with a plurality of mechanism attachment points;
a frame including a pair of spaced apart elongated beams and a pair of posts, the posts being releasably attached to the beams so as to extend between the beams and defining a plurality of interface attachment points, each of the beams comprising an elongated beam slot, the beams arranged so that the beam slots face one another and an opening is defined between the beams, the frame configured to lie flat against a door so that the interface attachment points align with the mechanism attachment points;
a plurality of elongated cross members, each cross member having a first coupling portion at a first end and a second coupling portion at a second end, the first and second coupling portions configured to slidably fit within the beam slots, each cross member further comprising an elongated through slot between the first and second coupling portions;
wherein the plurality of cross members span the opening between the beams; and
wherein a back of the frame defines a planar back surface.

6. The kit of claim 5, wherein the frame is configured so that the plurality of cross members can be inserted into the beam slots and removed from the beam slots when the post fasteners are loosened.

7. A method of mounting a mechanism onto a mount surface that comprises a plurality of pre-existing mount holes, comprising:
attaching a mounting interface to the mount surface, the mounting interface comprising a first beam, a second beam and a plurality of cross members, attaching the mounting interface comprising:
arranging the plurality of cross members so that a first coupling portion of each cross member is engaged in an elongated beam slot of the first beam and a second coupling portion of each cross member is engaged in an elongated beam slot of the second beam, each cross member having an elongated through-slot between the first coupling portion and the second coupling portion;
arranging the first and second beams so that back surfaces of the first and second beams are in contact with the mount surface, and the plurality of pre-existing mount holes is arranged in an opening defined between the first beam and the second beam;
positioning at least two of the cross members relative the first beam and second beam so that the through-slot of each of the at least two cross members is aligned with at least one of the plurality of pre-existing mount holes; and
advancing a fastener into each of the plurality of pre-existing mount holes and aligned cross member so that the beams are attached to the mount surface; and
attaching the mechanism to the mounting interface, comprising:
aligning a mechanism attachment point of the mechanism with an interface attachment point of a post that is connected to and extends between the first beam and the second beam; and
advancing a fastener through the aligned mechanism attachment point and interface attachment point.

8. The method of claim 7, wherein the plurality of cross members are disposed between the post and a second post that is also connected to and extends between the first beam and the second beam.

9. The method of claim 7, wherein positioning the at least two of the cross members comprises sliding the first and second coupling portions within the beam slots of their respective beams.

10. The method of claim 9, wherein a first one of the at least two of the cross members is disposed on a first side of the post and a second one of the at least two of the cross members is disposed on a second side of the post.

11. The method of claim 9, wherein a second post is connected to and extends between the first beam and the second beam, and post fasteners connect the post and second post to the first and second beams, and comprising tightening the fasteners.

12. The method of claim 11, comprising tightening the post fasteners after positioning the at least two of the cross members.

13. The method of claim 12, comprising moving a position of the second post relative to the first beam and second beam prior to tightening the post fasteners.

14. The method of claim 12, wherein the post comprises an elongated post through slot, and the interface attachment point is disposed within the post through slot.
